(19) United States
(12) Patent Application Publication
(10) Pub. No.: US 2005/0278347 A1
(43) Pub. Date: Dec. 15, 2005

(54) Method and system for extendable data conversion architecture

(76) Inventors: Werner G. Wolf, Wiesloch (DE); Ingo Braeuninger, Neuenstadt am Kocher (DE)

Correspondence Address: KENYON & KENYON, 1500 K STREET NW, SUITE 700, WASHINGTON, DC, 20005, US

(21) Appl. No.: 10/853,190

(22) Filed: May 26, 2004

(51) Int. Cl. G06F 7/00

(52) U.S. Cl. 707/100

(57) ABSTRACT

Embodiments of the present invention relate to a flexible and easily extendable architecture for software to format data for exchanges of electronic data. The architecture may separate general operations from format-specific operations. More particularly, the software may comprise a general engine to call one of a plurality of format-specific data conversion program modules. Each format-specific data conversion program module may comprise logic to convert a format of user data into a format required by a specific receiver, and logic to convert a format of sender data into a format of the user.

### FIELD OF THE INVENTION

Embodiments of the present invention relate to a flexible and easily extendable software architecture for converting data from a given user's format into various receiver-specific formats, and/or from various sender-specific formats into the user's format.

### BACKGROUND INFORMATION

Many businesses and other organizations exchange electronically-stored data. One example is the exchange of data between banks and their customers. Customers might send payments, among other kinds of data, to their banks in files stored electronically on machine-readable media, such as floppy disk or magnetic tape. The banks might, in return, send bank statements to their customers in electronically-stored files.

The data that needs to be supplied in such exchanges may have format requirements that vary widely. That is, different banks may set respective different protocols as to data type, content, organization and so on.

Complying with these various different protocols can be burdensome to the businesses and other organizations. This may be especially true when businesses expand and therefore have dealings with new banks. Business software exists for assisting businesses in complying with the various protocols, but such software may lack a flexible and easily extendable architecture. That is, known software may require laborious, unwieldy and error-prone “hard-coding” to accommodate new banking relationships and/or changes in the data formatting requirements in existing banking relationships. An improved approach is needed in view of the foregoing considerations.

### SUMMARY OF THE INVENTION

Embodiments of the present invention relate to a flexible and easily extendable architecture for software to format data for exchanges of electronic data. The architecture may separate general operations from format-specific operations. More particularly, the software may comprise a general engine to call one of a plurality of format-specific data conversion program modules. Each format-specific data conversion program module may comprise logic to convert a format of user data into a format required by a specific receiver, such as a bank, and logic to convert a format of sender data, such as data sent by a bank, into a format of the user. More specifically, the logic may be provided in a common set of methods that can be called by the general engine. The engine may handle supporting operations for the format-specific program modules, such as file handling operations, but have no format-specific information. By separating general operations from format-specific operations in the foregoing way, new data conversion requirements can be easily accommodated by simply coding a corresponding new format-specific program module, rather than substantially re-coding a more monolithic block of code.

### BRIEF DESCRIPTION OF THE DRAWINGS

FIG. 1 shows an example of converting a format of outbound data according to embodiments of the present invention;

FIG. 2 shows an example of converting a format of inbound data according to embodiments of the present invention;

FIG. 3 shows elements of format-specific data conversion program modules according to embodiments of the present invention;

FIG. 4 shows data structures used by the format-specific data conversion program modules according to embodiments of the present invention;

FIGS. 5A and 5B show process flows according to embodiments of the present invention; and

FIG. 6 shows a computer system for implementing embodiments of the present invention.

### DETAILED DESCRIPTION

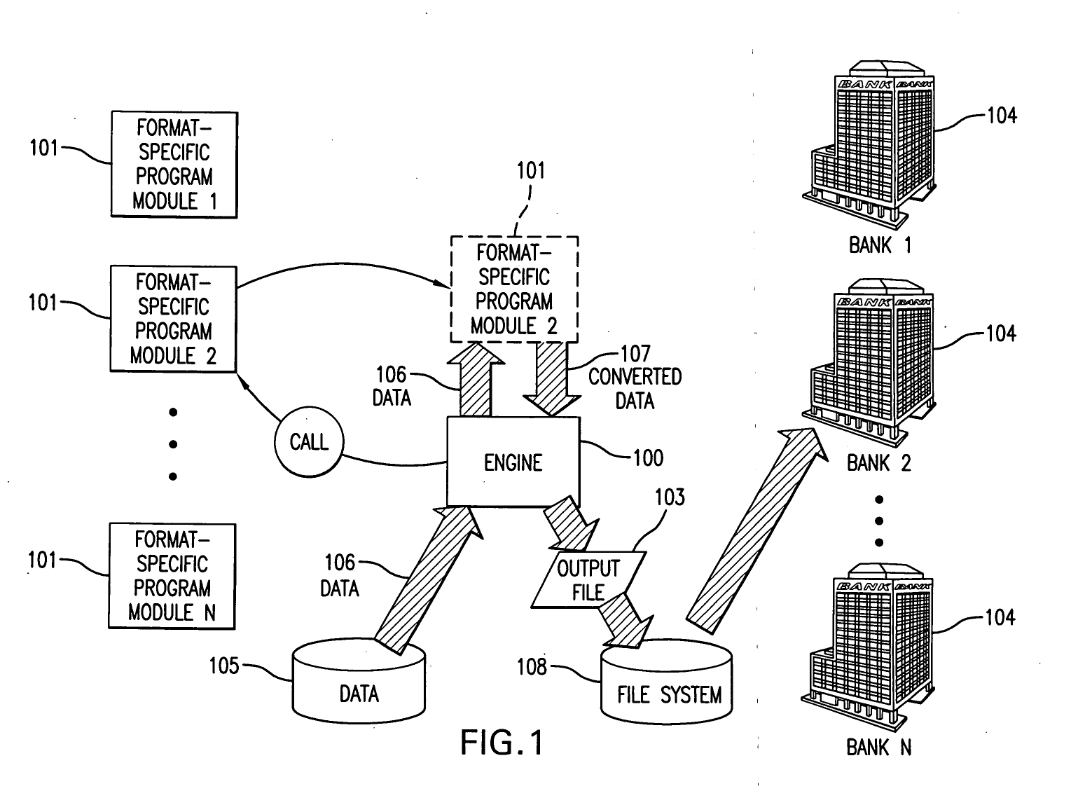

FIG. 1 shows an example of relationships between elements according to embodiments of the present invention. In the embodiments, based on a requirement to convert data to a particular receiver's format, a software engine 100 may execute to call one of a plurality of format-specific data conversion program modules 101. Each of the plurality of format-specific data conversion program modules 101 may contain logic for reformatting or converting data to meet the requirements of a respective receiver 104. When a called module 101 executes, it may re-format data 106 read by the engine 100 from a database 105 and passed to the executing module 101 by the engine 100. More specifically, the module 101 may re-format or convert a first format of the data 106 to a second format meeting specific requirements of the receiver 104, for example a bank. In the example of FIG. 1, format-specific program module 2 re-formats or converts data 106 according to the requirements of Bank 2 to generate converted data 107. The converted data could relate, for example, to payments to Bank 2. The module 2 may return the converted data 107 to the engine 100, which creates an output file 103 and writes the converted data 107 into the output file 103. The output file 103 may be stored electronically on a file system 108, which may be implemented in a machine-readable medium such as disk. The output file 103 could be downloaded to a portable medium such as floppy disk, magnetic tape or CD-ROM to be sent to Bank 2. Or, the output file 103 could be sent electronically, for example via e-mail, to Bank 2.

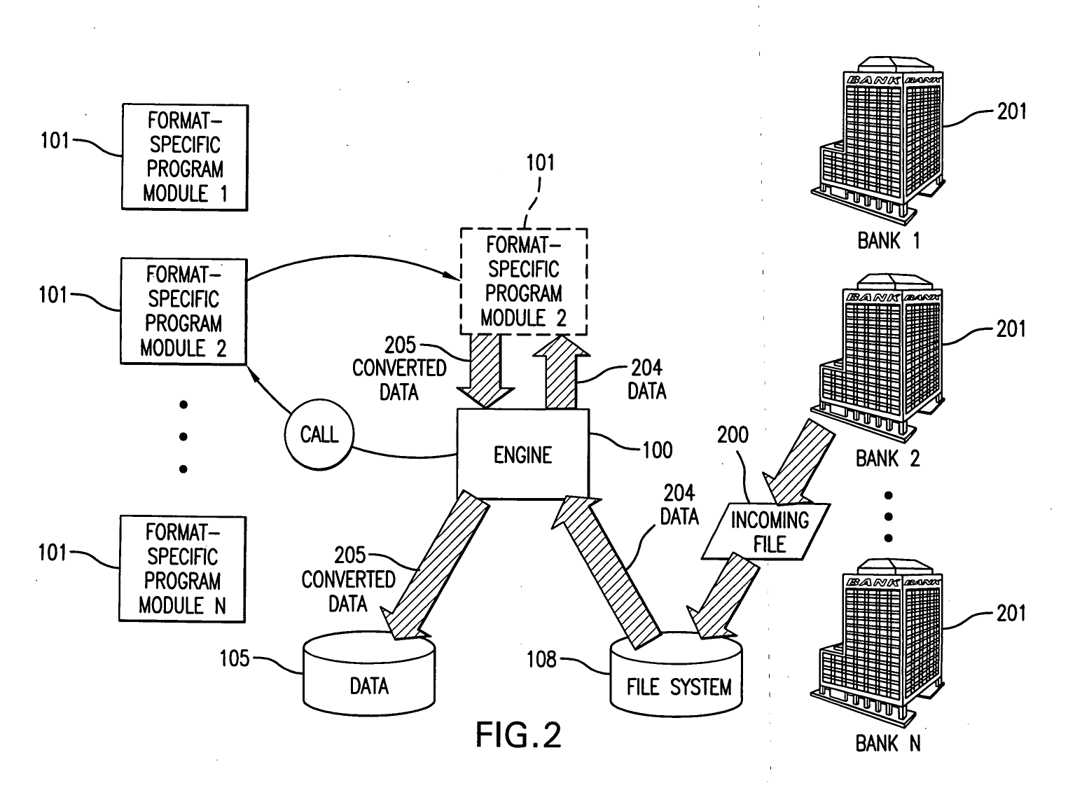

In the example of FIG. 1, the data that is converted is outbound data, that is, data on a database 105 that is converted to be sent to an external receiver. By contrast, data could be inbound. In this situation, a user could receive data from a sender, such as a bank, that needed to be re-formatted according to the user's requirements. Examples of such data include bank statements sent to a business to acknowledge payments made to given accounts. An example involving inbound data is illustrated in FIG. 2. As shown in FIG. 2, an incoming file 200 sent by a sender 201 may be stored on the file system 108. Based on a requirement to convert data in the incoming file 200 to a format that the user can handle, the engine 100 may call one of the plurality of format-specific program modules 101. Each of the plurality of format-specific program modules 101 may contain logic for re-formatting or converting data from one of a plurality of senders 201 to meet the data format requirements of the user. When a called module 101 executes, it may re-format data 204 read by the engine 100 from the incoming file 200 and passed to the executing module. The module 101 may re-format or convert a first format of the data 204 to a second format meeting specific requirements of the user, generating converted data 205. The module 101 may return the converted data 205 to the engine 100, which may write the converted data 205 to the user database 105, which may be embodied on a machine-readable medium such as disk.

In embodiments, the database 105 may be an SAP Business One database. SAP Business One is a known business software package designed by SAP Aktiengesellschaft for small-to-midsize companies that provides such capabilities such as accounting, reporting, financial management, inventory management and logistics, and sales force automation. The engine 100 may be implemented, for example, as an “add-on” to existing SAP Business One software, and be called or invoked from within, and/or by, the SAP Business One software. The SAP Business One software and add-on may execute within a networked client/server system, and stand in a server relationship with respect to various clients. More specifically, for example, the database 105 may be accessed via a network server using a database management system such as Microsoft SQL Server. For illustrative purposes, the description hereafter will refer to embodiments of the present invention as applied within a SAP Business One environment. However, it should be understood that the embodiments could be applied in other settings.

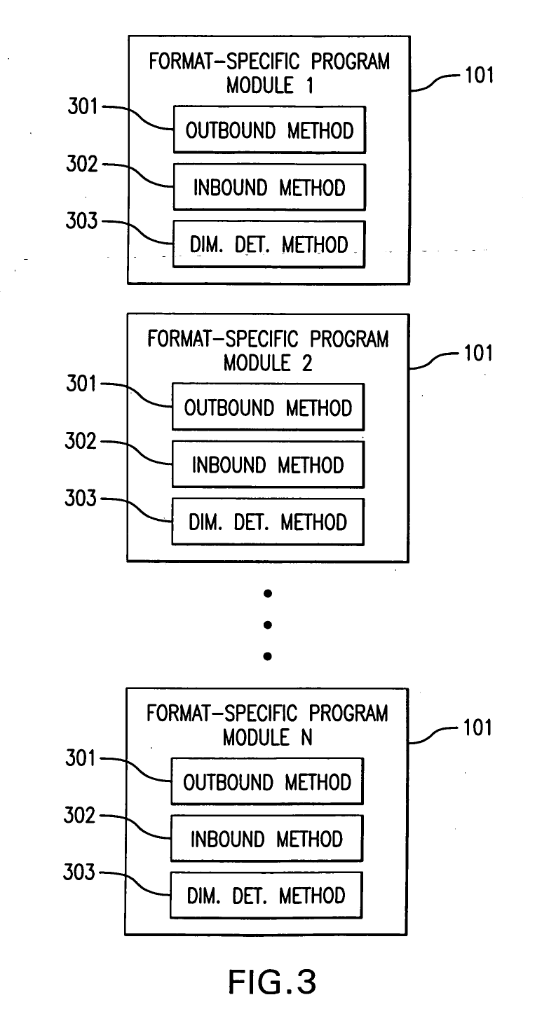

In embodiments, each module 101 could be a DLL (dynamic load library) or “executable” that executes in a Windows® operating system environment. Referring now to FIG. 3, each module 101 could have a common structure including the same methods. The methods may include a method 301 for handling outbound data (hereafter, “outbound method”), a method 302 for handling inbound data (hereafter, “inbound method”), and a dimension determining method 303 for determining the dimension of an incoming file. When a module is called, either of the outbound or inbound methods may be called by the engine. If the inbound method is to be called, the dimension determining method may be called first in order to determine how large an output file the engine needs to create for the converted incoming data. According to embodiments, the methods may be C++ methods.

Notwithstanding their common structure, each module 101 is, as noted earlier, format-specific. That is, each has logic corresponding to a specific receiver/sender, where the receiver and the sender are the same (such as the same bank). Thus, format-specific program module 1 could have logic corresponding to Bank 1, format-specific program module 2 could have logic corresponding to Bank 2, and so on. When data was received from Bank 1 or needed to be sent to Bank 1, format-specific program module 1 would be invoked to perform the necessary data conversion; when data was received from Bank 2 or needed to be sent to Bank 2, format-specific program module 2 would be invoked to perform the necessary data conversion, and so on.

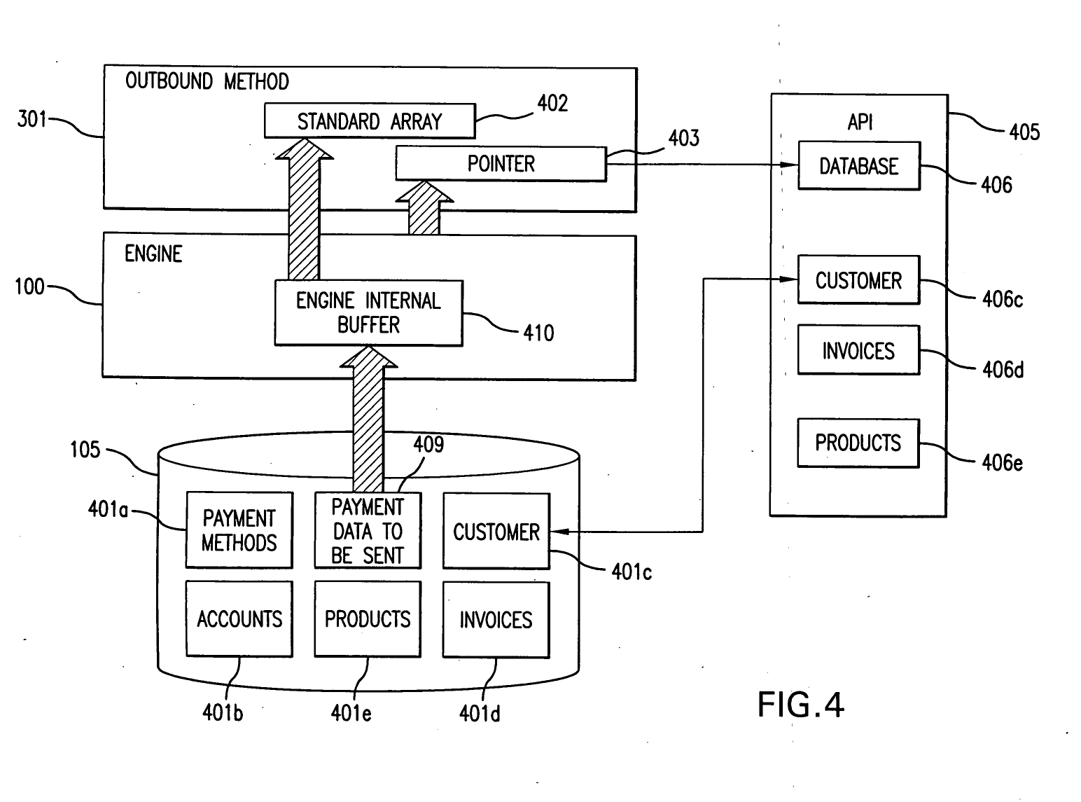

An example of the operation of the outbound method is discussed in more detail below. Referring to FIG. 4, the SAP Business One database 105 may comprise objects such as a Payment methods object 401a, an Accounts object 401b, a Customer object 401c, an Invoices object 401d, and a Products object 401e. The Payment methods object 401a may contain information as to which format-specific program module 101 and corresponding outbound method 301 is needed to convert data, such as payment data, destined for a particular receiver, say, Bank 2. The engine 100 may read the Payment methods object 401a to determine which format-specific program module 101 and corresponding outbound method 301 to call.

Assume that by reading the Payment methods object 401a the engine 100 determines that that format-specific program module 2 (see FIG. 1) is needed. The engine 100 may call (or load or otherwise invoke) format-specific program module 2 and then call the outbound method 301 of format-specific program module 2. The engine may construct a standard data field 402, which in embodiments may be an array, and pass payment data 409 (corresponding to unconverted data 106 as shown in FIG. 1) destined for Bank 2 in the standard array 402 to the outbound method 301 to be converted. The engine may store the payment data 409 temporarily in an engine internal buffer 410 before writing it to the standard array 402. The standard array 402 acts as a data “container” to transfer data between the engine and the outbound method.

The standard array is “standard” in that, although its specific content will correspond to a specific receiver, the content is of a kind that is required for a broad range of receivers. For example, most banks receiving a payment might require a customer name, an account number, and a payment amount, and these are examples of kinds of data that might be included in the standard array 402.

The pointer 403 may be used by the outbound method to access data required by a receiver but not present in the standard array. For example, suppose that for a particular user of the present invention, a particular bank (say, Bank 2 as in the present example) needed an address of a customer in addition to, say, a customer name, account number and payment amount. Further suppose that the standard array contained the customer number, name, and payment amount, but not the address of the customer. The outbound method might use the pointer to access the database to obtain the address of the customer and provide it for formatting and writing to the output file.

According to embodiments, the pointer 403 may be used to access data as follows. An SAP Business One API (Application Programmer's Interface) 405 may provide for accessing data on the SAP Business One database 105 through the mechanism of creating specific instances of objects corresponding to the database and to objects on the database. For example, reference number 406 in the API 405 indicates an instance of a database object corresponding to database 105. Reference number 406c indicates an instance in the API 405 of the Customer object 401c on the database 105, reference number 406d indicates an instance in the API 405 of the Invoices object 401d on the database 105, and reference number 406e indicates an instance in the API 405 of the Products object 401e on the database 105. The instances in the API can be used to access corresponding objects on the database 105.

More specifically, instantiated objects 406, 406c, 406d and 406e may be COM (Component Object Model) objects. COM is a software architecture developed by Microsoft® to build component-based applications. COM objects are discrete components, each with a unique identity, which expose interfaces that allow applications and other components to access their features.

In view of the above discussion, the pointer 403 may more particularly be a pointer to the instantiated COM database object 406. The engine 100 may initially instantiate the COM database object 406 in the API 405 and pass the pointer 403 to the outbound method 301. The outbound method can then use the instance of the database object 406 to instantiate other objects in the API 405. Thus, returning to the above example, the outbound method might use the pointer 403 to access the instantiated database object 406, and through the instantiated database object 406, create an instance of the Customer object 406c in the API 405. The outbound method 301 might then call methods in the instantiated Customer object 406c to access data associated with the corresponding Customer object 401c on the database 105. For example, the outbound method 301 might call a “read” method of the instantiated Customer object 406c in the API 405 to read an address of a customer associated with the Customer object 401c on the database 105. The instances 406d and 406e might be used in a similar manner.

The pointer feature described above is a further contributor to the flexibility and extendability provided by the present invention. Most or all of the data needed by a receiver will be provided in the standard array, and it is preferable to avoid modifying the standard array in order to maintain compatibility with as many receivers as possible. With the pointer, the need to modify the standard array for random unconventional requirements that may arise from time to time among various existing or new receivers is avoided. Instead, these random unconventional needs can be easily accommodated by providing access via the pointer directly to the user data.

More fundamentally, flexibility and extendability is, as noted earlier, enabled by the separation of the functionality of the engine from the functionality of the data conversion modules. More specifically, the engine provides base class support for the modules, while the modules only handle data conversion. For example, the engine performs basic file handling functionality in support of the modules. In a Windows® environment, for example, the engine might perform such functions as creating a new output file 103 for writing data converted by the module, opening the file, closing it, assigning it to a specific folder, saving it on disk, and so on. The modules, therefore, need not handle any of the details of file handling or other aspects of interfacing with an operating system. Accordingly, the coding of the modules is simplified and only needs to address data formatting requirements.

The inbound method 302 is discussed next, with reference to elements in FIG. 2, FIG. 3 and FIG. 4. When an incoming file 200 is received from a sender 201 by a user of the present invention, it may need conversion from a sender-specific format into a format that can be handled by SAP Business One. An example of such a file is a bank statement containing records which need to be applied to user records, for example, to show acknowledgement of payments. Before being converted, the incoming file 200 may be stored on the file system 108.

The inbound method operates similarly to the outbound method. Like the outbound method, the inbound method is called by the engine, which passes the inbound method a standard array 402 and a pointer 403. However, in contrast to the outbound method, the inbound method may not be called by the engine until after the engine calls the dimension determining method 303 to determine the dimension (number of records) of an incoming file. The dimension determining method 303 may need to be executed because the data being converted is not internally generated, as by contrast is the case with the outbound method. Therefore, the engine, which writes the converted data 205 for the inbound method via the SAP Business One API 405, must learn from the dimension determining method how big the incoming file 200 (e.g, how many payment transactions the incoming file includes) so as to create a temporary engine internal buffer 410 that can accommodate it. The dimension determining method, as a method of a format-specific data conversion module 101 tailored to the sender 201, has knowledge about the specific format of the incoming file from the sender and thus can determine its dimension.

After the dimension determining method determines the dimension of the incoming file, it passes the dimension to the engine, which creates a corresponding standard array 402 and reads unconverted data 204 from the incoming file 200 on the file system 108 into the standard array. The engine calls the inbound method, passing it the standard array 402 and a pointer 403 to access the user database for information needed but not in the standard array. The inbound method processes the incoming data stored in the standard array. If data is needed by the inbound method but not present in the standard array, the inbound method may use the pointer to read data on the SAP Business One database 105. The inbound method converts the data 204 from the incoming file (passed via the standard array as a data container) to a format that can be handled by SAP Business One, and returns converted data 205 to the engine. To apply the converted data 205 to the SAP Business One database, the engine may create an instance of an object of the SAP Business One API containing methods for writing the converted data to the database, and execute the methods.

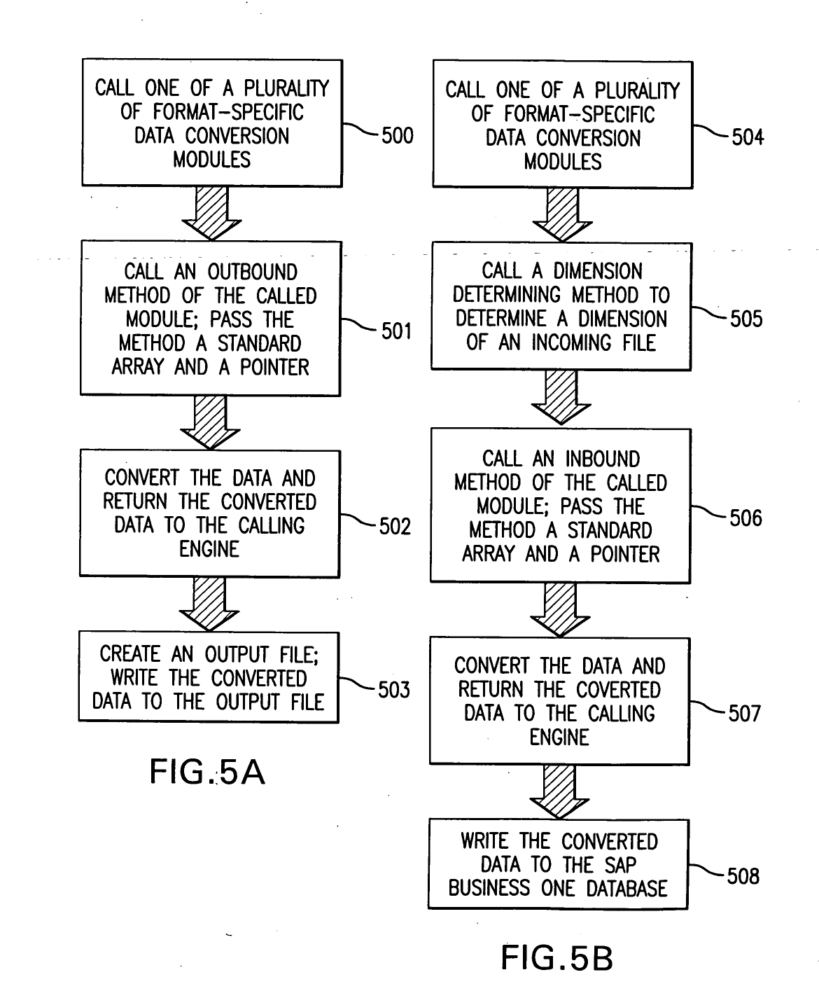

In view of the above, FIG. 5A shows a process flow for handling outgoing data according to embodiments of the present invention. As shown in block 500, to convert data in a user format to data in a receiver format, the engine may call one of a plurality of format-specific data conversion program modules, where the called module has conversion logic corresponding to the receiver. The engine may call an outbound method of the called module, and pass the outbound method a standard array containing user data to be converted and a pointer to user data for any data needed but not present in the standard array, as shown in block 501.

As shown in block 502, the outbound method may convert the user data and return converted data to the engine. As shown in block 503, the engine may create an output file and write the converted data in the output file.

FIG. 5B shows a process flow for handling incoming data according to embodiments of the present invention. As shown in block 504, to convert data in a sender format to data in SAP Business One format, the engine may call one of a plurality of format-specific data conversion program modules, where the called module has conversion logic corresponding to the sender. The engine may call a dimension determining method to determine a dimension of an incoming file containing the sender data, as shown in block 505. After the dimension is determined, the engine may call an inbound method of the called module, and pass the inbound method a standard array containing sender data to be converted and a pointer to sender data for any data needed but not present in the standard array, as shown in block 506.

As shown in block 507, the inbound method may convert the sender data and return it to the engine. As shown in block 508, the engine may write the converted data in the SAP Business One database.

Embodiments of the present invention may further relate to data conversion for reporting foreign trade activities. Governments of countries typically require foreign businesses that conduct trade in the countries to report their activities to respective foreign trade offices of the countries. Like banks and their associated financial data, different countries may have different respective format requirements for foreign trade reporting data. To meet such requirements, embodiments of the present invention may comprise a plurality of format-specific data conversion modules and an engine to call the modules and provide supporting functions as described above. Each format-specific module contains logic for converting outgoing data into the format required by a specific country. For example, one format-specific module might contain logic for converting foreign trade reporting data according to the format requirements of the foreign trade office of Brazil, while another format-specific module might contain logic for converting foreign trade reporting data according to the format requirements of the foreign trade office of Sweden, and so on. The modules may contain outbound methods but not inbound methods, since there is typically no reciprocal sending of data from the foreign trade offices.

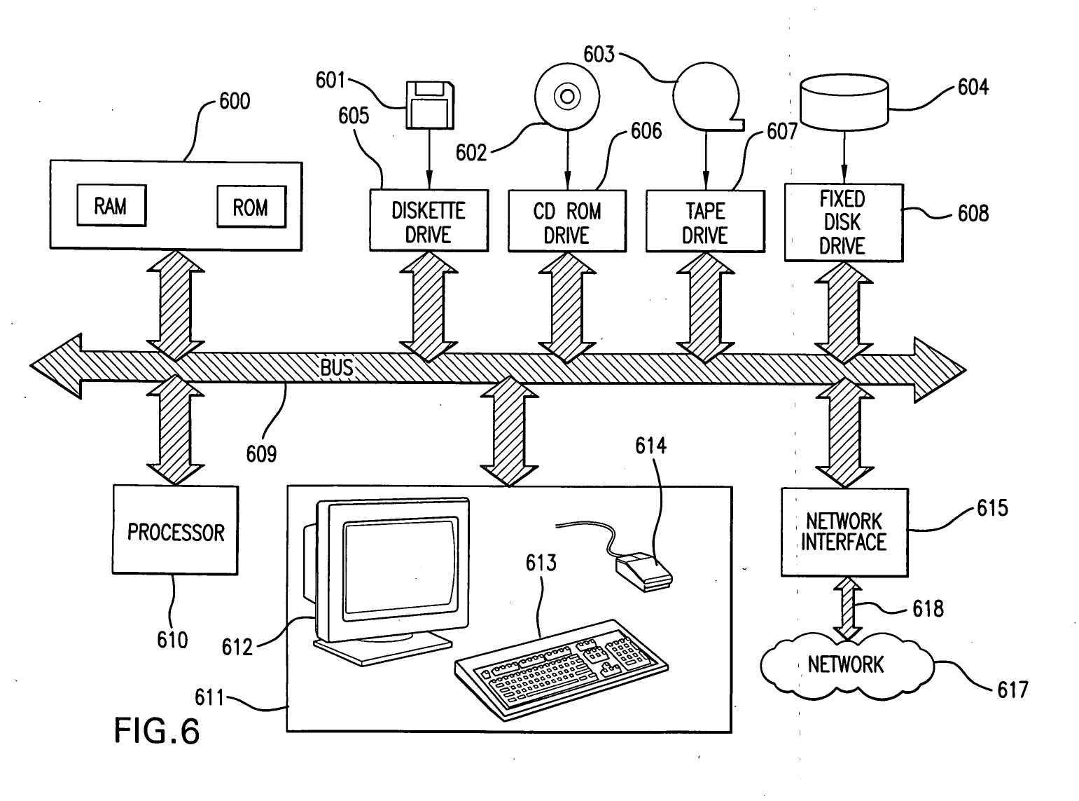

FIG. 6 shows a high-level representation of a computer system for implementing embodiments of the present invention, such as might be realized by a variety of known and commercially available hardware and software elements. The system may comprise a memory 600 including ROM and RAM, processor 610 and user interface 611 comprising a display device 612, keyboard 613 and mouse 614. Elements may communicate via a system bus 609. The system may further comprise a network 617 connected by a network medium 618 and network interface 615.

A computer program or collection of programs comprising computer-executable instructions according to embodiments of the present invention may be stored and transported on machine-readable media such as diskette 601, CD-ROM 602, magnetic tape 603 and fixed disk 604. The computer instructions may be retrieved from the machine-readable media 601-604 using their respective reading devices 605-608 into memory 600, and executed by a processor 610. The functionality disclosed hereinabove for performing the embodiments may find specific implementations in a variety of forms, which are considered to be within the abilities of a programmer of ordinary skill in the art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

1. A method comprising:
calling one of a plurality of per receiver format-specific data conversion program modules to convert data to a receiver-specific format;
calling an outbound method of the called format-specific data conversion program module;
passing the outbound method a data field comprising data to be formatted for the receiver corresponding to the called module;
passing the outbound method a pointer for access to data if needed but not present in the data field;
executing the outbound method to convert the data to the receiver-specific format;
creating an output file;
writing the converted data to the output file; and
saving the output file on a machine-readable medium.

2. The method of claim 1, wherein the format-specific program module is a DLL that executes in a Windows environment.

3. The method of claim 1, wherein the outbound method is a C++ method.

4. The method of claim 1, wherein the receiver is a bank.

5. The method of claim 1, wherein the receiver is a governmental foreign trade office, and the data relates to foreign trade.

6. A method comprising:
calling one of a plurality of per sender format-specific data conversion program modules to convert sender data to a desired format;
calling an inbound method of the called format-specific data conversion program module;
passing the inbound method a data field comprising sender data to be formatted according to the desired format;
passing the inbound method a pointer for access to data if needed but not present in the data field;
executing the inbound method to convert the data to the desired format; and
writing the converted data to the database on a machine-readable medium.

7. The method of claim 6, further comprising calling a dimension determining method to determine a dimension of the sender data.

8. The method of claim 6, wherein the format-specific program module is a DLL that executes in a Windows environment.

9. The method of claim 6, wherein the inbound method is a C++ method.

10. The method of claim 6, wherein the sender is a bank.

11. A machine-readable medium comprising:
a plurality of format-specific data conversion program modules, each of the format-specific data conversion program modules comprising logic to either convert user data into a format specific to a receiver or convert sender data to a format specific to the user, wherein the receiver and the sender may be the same;
an engine comprising computer-executable instructions to call one of the plurality of format-specific data conversion program modules to perform one of converting user data to a receiver format or converting sender data to a user format;
each of the format-specific data conversion program modules including an inbound method for converting the sender data and an outbound method for converting the user data, the methods callable by the engine;
the engine to pass an array comprising data to be converted to a called method, and further pass the called method a pointer to data if needed but not present in the array;
each of the inbound and the outbound methods to return the engine converted data in the array; and
the engine to further create an output file and write the converted data into the output file for the outbound method, or to apply the converted data to a user database for the inbound method.

12. A system comprising:
an SAP Business One database;
a software engine to read data from and write data to the SAP Business One database;
a plurality of format-specific data conversion program modules, each of the format-specific data conversion program modules comprising logic to either convert data on the SAP Business One database into a format specific to a receiver or convert sender data to a format specific to the SAP Business One database, wherein the receiver and the sender may be the same;
an engine comprising computer-executable instructions to call one of the plurality of format-specific data conversion program modules to perform one of converting the data on the SAP Business One database to a receiver format or converting sender data to the SAP Business One database format;
each of the format-specific data conversion program modules including an inbound method for converting the sender data and an outbound method for converting the SAP Business One database data, the methods callable by the engine;
the engine to pass an array comprising data to be converted to a called method, and further pass the called method a pointer to data on the SAP Business One database if needed but not present in the array;
each of the inbound and the outbound methods to return the engine converted data in the array; and
the engine to further create an output file and write the converted data into the output file for the outbound method, or to apply the converted data to the SAP Business One database for the inbound method.

13. The system of claim 12, wherein the pointer points to an SAP Business One database object instantiated in an SAP Business One API.

14. The system of claim 13, wherein the outbound and inbound methods use the pointer to instantiate objects in the API corresponding to objects on the SAP Business One database to access data on the SAP Business One database.

15. A data reporting agent, comprising:
responsive to a call from SAP Business One software, means for reading data to be reported to an external receiver from an SAP Business One database;
means for calling formatting logic to format the data in a receiver-specific format; and
means for outputting the formatted data to a machine-readable medium.

16. The data reporting agent of claim 15, wherein the agent passes the formatting logic the data read from the SAP Business One database in an array, and further passes the formatting logic a pointer to data on the SAP Business One database if needed but not present in the array.

17. The data reporting agent of claim 15, wherein the receiver is a bank.

18. The data reporting agent of claim 15, wherein the receiver is a governmental foreign trade office, and the data relates to foreign trade.

19. A data reporting agent, comprising:
responsive to a call from SAP Business One software, means for reading data sent by an external sender from a machine-readable medium;
means for calling formatting logic to convert the data from a sender-specific format to an SAP Business One format; and
means for applying the formatted data to an SAP Business One database.

20. The data reporting agent of claim 19, wherein the agent passes the formatting logic the data read from the machine-readable medium in an array, and further passes the formatting logic a pointer to data on the SAP Business One database if needed but not present in the array.

21. The data reporting agent of claim 19, wherein the sender is a bank.

22. A machine-readable medium storing computer-executable instructions to:
responsive to a call from SAP Business One software, read data to be reported to an external receiver from an SAP Business One database;
call formatting logic to format the data in a receiver-specific format; and
output the formatted data to a machine-readable medium.

23. The machine-readable medium of claim 22, the instructions further to:
pass the formatting logic the data read from the SAP Business One software database in an array; and
pass the formatting logic a pointer to data on the SAP Business One database if needed but not present in the array.

24. A machine-readable medium storing computer-executable instructions to:
responsive to a call from SAP Business One software, read data sent by an external sender from a machine-readable medium;
call formatting logic to convert the data from a sender-specific format to an SAP Business One format; and
apply the formatted data to an SAP Business One database.

25. The machine-readable medium of claim 24, the instructions further to:
pass the formatting logic the data read from the machine-readable medium in an array; and
pass the formatting logic a pointer to data on the SAP Business One database if needed but not present in the array.

26. A data reporting agent, comprising:
responsive to a call from SAP Business One software, means for reading data to be reported to an external receiver from an SAP Business One database;
means for calling formatting logic to format the data read from the SAP Business One database in a receiver-specific format;
means for outputting the data formatted in a receiver-specific format to a machine-readable medium;
responsive to a call from SAP Business One software, means for reading data sent by an external sender from a machine-readable medium;
means for calling formatting logic to convert the data sent by an external sender from a sender-specific format to an SAP Business One format; and
means for applying the data formatted in the sender-specific format to an SAP Business One database.

27. A machine-readable medium comprising computer-executable instructions to:
responsive to a call from SAP Business One software, read data to be reported to an external receiver from an SAP Business One database;
call formatting logic to format the data read from the SAP Business One database in a receiver-specific format;
output the data formatted in a receiver-specific format to a machine-readable medium;
responsive to a call from SAP Business One software, read data sent by an external sender from a machine-readable medium;
call formatting logic to convert the data sent by an external sender from a sender-specific format to an SAP Business One format; and
apply the data formatted in the sender-specific format to an SAP Business One database.
